(19) United States
(12) Patent Application Publication
(10) Pub. No.: US 2014/0130906 A1
(43) Pub. Date: May 15, 2014

(54) SYSTEMS AND METHODS FOR ELECTRONICALLY CONTROLLING THE FLOW RATES OF FLUIDS

(71) Applicant: Mindray DS USA, Inc., (US)

(72) Inventors: Christine M. Manfredo, S. Plainfield, NJ (US); Joseph M. Petruzzelli, Paramus, NJ (US); Scot C. Carriker, Malvern, PA (US); Huang Chenghua, Shenzhen (CN); Zhu Guanyu, Shenzhen (CN)

(73) Assignee: MINDRAY DS USA, INC., Mahwah, NJ (US)

(21) Appl. No.: 13/677,161

(22) Filed: Nov. 14, 2012

(51) Int. Cl. G05D 7/06

(52) U.S. Cl. CPC G05D 7/0617
USPC 137/486

(57) ABSTRACT

In various embodiments, two or more electronic flow selectors of an electronic fluid flow control system may be used to control the flow rates of multiple fluids. In a total flow control mode, a first electronic flow selector may be used to select a total flow rate of two or more fluids. A second electronic flow selector may be used to select a flow rate or ratio of a flow rate of one fluid to the total flow rate of the two or more fluids. In a direct flow control mode, each electronic flow selector may be used to select a flow rate of a unique fluid. One of the fluids may be oxygen, and the other fluid, a balance gas, may be selected as either nitrous oxide or air using an electronic balance gas selector.

### TECHNICAL FIELD

This disclosure relates generally to controlling the flow of fluids via electronic controls. Particularly, this disclosure relates to electronic flow selectors and on-screen controls for controlling the flow rate of fluids in multiple selectable modes.

### SUMMARY

In various instances, the flow rates of fresh gases, such as oxygen, nitrous oxide, and air, in modern anesthesia delivery systems may be controlled by a practitioner either electronically or mechanically. In various embodiments, one or more rotatable flow selectors, such as rotatable knobs, may be configured to electronically control a flow rate of a gas when in a powered state. Alternatively or additionally, an on-screen display may be configured to allow a user to electronically control the flow rate of one or more gases.

The anesthesia delivery system may also include manual backup controls for controlling the flow rate of one or more of the gases when in an unpowered state. In one embodiment, a three-way selector valve and/or a combination of normally-open valves and normally-closed valves may be used to selectively enable the flow of gas from either electronically controlled electronic proportional valves or mechanically operated needle valves. The valve assemblies, flow selectors, and position detection systems may be utilized with or without variation in any of a wide variety of flow control systems.

In various embodiments, when a fluid flow control system is in a powered state, a three-way selector valve, or other diversion valve system, may allow fluid from the electronically controlled electronic proportional valves to be delivered to a patient. When the fluid flow control system is in an unpowered state or a manual override is selected, the three-way selector valve may allow fluid from the mechanically controlled needle valves to be delivered to a patient. Alternatively, a diversion valve system may include a combination of normally-open and normally-closed valves instead of or in addition to a three-way selector valve, as described herein. In some embodiments, the diversion valve system may be located between a fluid supply and a fluid control valve. In other embodiments, the diversion valve system may be located between a fluid control valve and a fluid output.

An electronic flow control valve, such as an electronically controlled proportional valve, may be configured to selectively receive a fluid from a fluid supply. An electronic flow selector may allow a practitioner to select a flow rate of a fluid via the electronic control valve. From the perspective of the user, the electronic flow selector may be functionally similar to a control knob for a mechanical needle valve. For example, a user may rotate a knob clockwise or counterclockwise in order to decrease or increase, respectively, the flow rate of a particular fluid. A rotary encoder may electronically encode a selection made via the electronic flow selector and transmit the encoded selection to an electronic controller. The electronic controller may transmit a control signal to the electronic flow control valve to control the flow rate of the fluid based on the selection made via the electronic flow selector.

Additionally or alternatively, an on-screen display may allow a practitioner to select a flow rate of one or more fluids. For example, a user may enter a numeric value associated with a total flow rate, a percentage or ratio of fluids, a flow rate of a particular fluid, and/or other numeric value associated with the flow rate of one or more fluids. The on-screen display may be utilized in a direct flow control mode in which a user may provide a first input to directly adjust the flow rate of oxygen and a second input to directly adjust the flow rate of either nitrous oxide or air. Alternatively the on-screen display may be utilized in a total flow control mode in which a first input is provided to select the total flow rate of all the gases (e.g., the selected balance gas and the oxygen), and a second input is provided to select the concentration of oxygen to mix with the selected balance gas (air or nitrous oxide).

The selected values, appropriate ratios, and/or other control settings may be computed and graphically represented in digital or mechanically operated flow tubes (e.g., variable area flowmeters). The digital display may display a numeric value associated with the delivery flow rate of each individual gas (e.g., in liters per minute). In various embodiments, the digital display may display the total flow rate, the ratio of the two gases, the total flow rate with respect to an optimum flow rate, and/or other numeric values, charts, graphs, percentages, and the like associated with the flow rates.

In some embodiments, the system may utilize two electronic flow selectors to selectively control the flow rate of oxygen and nitrous oxide, or oxygen and air. The flow selectors may be utilized in a direct flow control mode in which a first electronic flow selector is used to directly adjust the flow rate of oxygen and a second electronic flow selector is used to directly adjust the flow rate of either nitrous oxide or air. A digital display associated with the selected flow rates may display the selected flow rates of each gas, a total flow rate, the ratio of the two gases, the total flow rate with respect to an optimum flow rate, and/or other numeric values, charts, graphs, percentages, and the like.

The flow selectors may additionally, selectively, or alternatively be used in a total flow control mode in which a first electronic flow selector is used to adjust the total flow rate of the selected balance gas (air or nitrous oxide) and oxygen delivered and a second electronic flow selector is used to control the concentration of oxygen to mix with the selected balance gas (air or nitrous oxide). The ratio may be computed and graphically represented in digital or mechanically operated flow tubes (e.g., variable area flowmeters). The digital display may display a numeric value associated with the delivery flow rate of each individual gas (e.g., in liters per minute). In various embodiments, the digital display may display the total flow rate, the ratio of the two gases, the total flow rate with respect to an optimum flow rate, and/or other numeric values, charts, graphs, percentages, and the like associated with the flow rates.

The electronic flow control valve may include an electronic proportional valve and the electronic flow selector may include a rotary knob configured to be manually rotated by a user. Alternatively, the electronic flow selector may include any of a wide variety of digital and/or analog selectors with accompanying encoders. For example, a slider may be adjusted between a zero flow rate point and a 100 percent flow rate point. A sliding encoder may electronically encode the selection made via the slider.

In some embodiments, one or more unique electronic flow control valves may be used to control the flow rate of each available fluid. For example, a first electronic flow control valve may control the flow rate of oxygen. A second electronic flow control valve may control the flow rate of nitrous oxide. A third electronic flow control valve may control the flow rate of air. A fourth electronic flow control valve may control the flow rate of a fourth gas.

Similarly, a unique electronic flow selector may be available to control the flow rate of each of the electronic flow control valves. Alternatively, one or more of the electronic flow selectors may be selectively assignable to control two or more electronic flow control valves. For example, a system may include three electronic flow control valves, one for oxygen, one for air, and one for nitrous oxide. The system may utilize only two electronic flow selectors, one of which may be selectively used to control either the flow rate of the air or the flow rate of the nitrous oxide, and the other assigned to control the flow rate of oxygen. Any electronic flow selector may be permanently assigned or selectively assigned to control the flow rate of any one or more of the available fluids.

In addition to electronic control valves, one or more mechanical flow control valves may be configured to control the flow rate of each of the available fluids. For example, a unique needle valve may be used to mechanically control the flow rate of each available fluid. A manual flow selector, such as a knob or slider, may be actuated by a practitioner to mechanically adjust the flow rate through each of the needle valves. In some embodiments, the manual flow selectors may be disabled and/or retracted to prevent adjustments when the system is in a powered state.

In a powered state, one or more electronic flow selectors may be adjusted to control the flow rate of one or more fluids through one or more electronic flow control valves. In the powered state, backup mechanical flow control valves may be disabled and/or otherwise prevented from supplying a fluid or combination of fluids. Moreover, in the powered state, manual flow selectors associated with the backup mechanical flow control valves may be disabled and/or retracted to prevent adjustments.

In an unpowered state, or when a manual override selection is made, the electronic flow control valves may be disabled and/or otherwise prevented from supplying a fluid or combination of fluids. Manual flow selectors may be enabled and/or deployed to allow a practitioner to directly control a flow rate of one or more fluids through the backup mechanical flow control valves.

In some embodiments, when the manual flow selectors are retracted, such as upon power restoration or a reset of the system, the flow rate of each of the backup mechanical flow control valves may be reset to a home state, in which a predetermined flow rate of a gas will automatically flow when the system enters an unpowered state.

In one embodiment, the electronic flow control valve may comprise an electronically controlled stepper motor configured to adjust the flow rate of a fluid through a mechanical flow control valve, such as a needle valve. In various examples provided herein, the fluid is described as a gas, such as oxygen, nitrous oxide, and/or air. However, any of a wide variety of liquids and/or gases may be used in conjunction with various embodiments of the systems and methods described herein.

### BRIEF DESCRIPTION OF THE DRAWINGS

FIG. 1 illustrates an anesthesia delivery machine configured with three manual flow selectors, one each for controlling the flow of oxygen, nitrous oxide, and air.

FIG. 2 illustrates an anesthesia delivery machine configured with two electronic flow selectors, configurable to selectively control each of the three gases, and three selectively deployable backup manual flow selectors, for controlling each of the three gases.

FIG. 3 illustrates a diagram of an anesthesia delivery system configured with electronic and backup manual controls for controlling the flow of oxygen, nitrous oxide, and air.

FIG. 4 illustrates a close-up view of a control panel of an anesthesia delivery machine, including two electronic flow selectors selectively configurable to directly control either oxygen and nitrous oxide or oxygen and air in a direct flow control mode.

FIG. 5 illustrates a close-up view of a control panel of an anesthesia delivery machine, including two electronic flow selectors selectively configurable to control the ratio of oxygen to the total flow rate of oxygen combined with nitrous oxide or air.

FIG. 6 illustrates a wider view of a control panel of an anesthesia delivery machine, including dual mode electronic flow selectors and backup manual flow controls for controlling the flow of three gases independently.

FIG. 7A illustrates an on-screen display configured to allow a user to select the relative flow rates of oxygen and a balance gas (air or nitrous oxide) in a total flow control mode.

FIG. 7B illustrates the on-screen display for selecting the relative flow rates of oxygen and a balance gas in the total flow control mode, including a drop down menu for selecting a balance gas.

FIG. 7C illustrates the on-screen display for selecting the relative flow rate of oxygen and nitrous oxide in the total flow control mode.

FIG. 7D illustrates the on-screen display for selecting the relative flow rate of oxygen and air in the total flow control mode.

FIG. 8A illustrates the on-screen display for selecting the relative flow rate of oxygen and air in a direct flow control mode.

FIG. 8B illustrates the on-screen display for selecting the relative flow rate of oxygen and nitrous oxide in a direct flow control mode.

FIG. 9A illustrates a wide view of an on-screen display of an anesthesia delivery machine for selecting the relative flow rate of oxygen and a balance gas in a total flow control mode.

FIG. 9B illustrates a wide view of an on-screen display of an anesthesia delivery machine for selecting the relative flow rate of oxygen and a balance gas in a direct flow control mode.

### DETAILED DESCRIPTION

An electronic flow control valve, such as an electronically controlled proportional valve, may be configured to selectively receive a fluid from a fluid supply. An electronic flow selector may allow a practitioner to select a flow rate of the first fluid via the electronic control valve. From the perspective of the user, the electronic flow selector may be functionally similar to a control knob for a mechanical needle valve. For example, a user may rotate a knob clockwise or counterclockwise in order to decrease or increase the flow rate of a particular fluid. A rotary encoder may electronically encode a selection made via the electronic flow selector and transmit the encoded selection to an electronic controller. The electronic controller may transmit a control signal to the electronic flow control valve to control the flow rate of the fluid based on the selection made via the electronic flow selector.

One or more of the electronic flow selectors may be selectively assignable to control two or more electronic flow control valves. For example, a system may include three electronic flow control valves, one for oxygen, one for air, and one for nitrous oxide. The system may utilize only two electronic flow selectors, one of which may be selectively used to control either the flow rate of the air or the flow rate of the nitrous oxide, and the other assigned to control the flow rate of oxygen. Any electronic flow selector may be permanently assigned or selectively assigned to control the flow rate of any one or more of the available fluids.

In some embodiments, the system may utilize two electronic flow selectors to selectively control the flow rate of oxygen and nitrous oxide, or oxygen and air. The flow selectors may be utilized in a direct flow control mode in which a first electronic flow selector is used to directly adjust the flow rate of oxygen and a second electronic flow selector is used to directly adjust the flow rate of either nitrous oxide or air. A digital display associated with the selected flow rates may display the selected flow rates of each gas, a total flow rate, the ratio of the two gases, the total flow rate with respect to an optimum flow rate, and/or other numeric values, charts, graphs, percentages, and the like associated with the flow rates.

The flow selectors may additionally, selectively, or alternatively be used in a total flow control mode in which a first electronic flow selector is used to adjust the total flow rate of the selected balance gas (air or nitrous oxide) and oxygen delivered and a second electronic flow selector is used to control the concentration of oxygen to mix with the selected balance gas (air or nitrous oxide). The ratio may be computed and graphically represented in digital or mechanically operated flow tubes (e.g., electronic displays resembling variable area flowmeters). The digital display may display a numeric value associated with the delivery flow rate of each individual gas (e.g., in liters per minute). In various embodiments, the digital display may display the total flow rate, the ratio of the two gases, the total flow rate with respect to an optimum flow rate, and/or other numeric values, charts, graphs, percentages, and the like associated with the flow rates.

Additionally or alternatively, an on-screen display may allow a user to select the flow rate of one or more gases in either the direct flow control mode or the total flow control mode. An on screen display may include quick keys for selecting common flow rates of particular gases, a keypad for entering a numeric value associated with a flow rate of one or more gases, digital knobs, digital sliders, up and down arrows, and/or other digitally selectable controls for selecting a flow rate. The electronic selections made via the on-screen display may be transmitted to an electronic controller. The electronic controller may transmit a control signal to the electronic flow control valves to control the flow rate of one or more fluids based on the selections made via the on-screen display.

According to various embodiments, in a direct flow control mode, a user may enter a numeric value to select the flow rate of a balance gas (air or nitrous oxide), and a numeric value to select the flow rate of oxygen via the on-screen display. A digital display (potentially the same display as the on-screen display) may display the selected flow rates of each gas, a total flow rate, the ratio of the two gases, the total flow rate with respect to an optimum flow rate, and/or other numeric values, charts, graphs, percentages, and the like.

In a total flow control mode, a user may enter a numeric value to select the total flow rate of the selected balance gas (air or nitrous oxide) and oxygen delivered and a numeric value to select the concentration of oxygen to mix with the selected balance gas (air or nitrous oxide). In various embodiments, a user may select either the total flow control mode or the direct flow control mode. The on-screen display may allow inputs to be provided via touch, voice, a mouse, a keyboard, a joystick, and/or another peripheral input device.

While electronic flow control of gases may be useful during anesthesia delivery, it may be desirable to provide manual backup controls as well. For example, in the event of power loss, it may be desirable to continue supplying gases during anesthesia delivery. In some embodiments, electronic controls, such as trim knobs, used in conjunction with encoders, may facilitate the electronic adjustment of the flow rate of one or more gases during anesthesia delivery. Separate backup flow selectors (e.g., knobs) may be available for use in the event of power failure or power unavailability. In such embodiments, the practitioner may need to engage the backup knobs, switch the machine from an electronic mode to a manual mode, and/or ensure that the manual knobs are set to a desirable state prior to switching to a manual mode.

Power loss during anesthesia delivery may be confusing and/or disruptive during a critical medical procedure. It may be an inconvenience and/or confusing for a practitioner to see two sets of knobs for controlling the same set of gases. In various embodiments of the present disclosure, flow selectors, such as rotary knobs, may be electronically operable when a fluid flow control system is in a powered state and backup flow selectors may be retracted or otherwise disabled when a fluid flow control system is in a powered state. Confusion may be minimized because the electronic selectors are functionally similar to the manual flow selectors. In an unpowered state, or when a practitioner engages the backup system, the backup flow selectors may be deployed or otherwise enabled.

The number of diversion valve systems, mechanically operated valves, electronically operated valves, controllers, encoders, flow selectors, and/or other components described herein may correspond to the number of gases (or liquids) available. In various anesthesia delivery systems, oxygen, nitrous oxide, and/or air may each be independently controllable and/or proportionally controllable. A mixture of one or more gases may be used in conjunction with a vaporizer to deliver anesthesia.

In one embodiment, a diversion valve system may direct the flow of a gas (or liquid) from a gas supply to either a mechanical flow control valve, such as a mechanically operated needle valve, or an electronic flow control valve, such as an electronic proportion valve, depending on whether the system has power or if a backup system has been engaged.

According to various embodiments, the diversion valve system may include normally-open and normally-closed valves in order to selectively prevent the gas from flowing from (or to) both the mechanically operated needle valve and the electronic proportion valve. The diversion valve system may be implemented using any of a wide variety of valves and/or control systems, such as a three-way selector valve.

In some embodiments, the needle valve may be used as the mechanical flow control valve and the same needle valve in combination with the electronic stepper motor may be considered the electronic flow control valve. In various embodiments, the flow selector may comprise any of a wide variety of knobs, buttons, rotatable actuators, slides, and/or other analog and/or digital selection devices.

In various embodiments, a controller or control system may be implemented as any combination of hardware, firmware, and/or software. For example, a controller may be implemented as a field-programmable gate array (FPGA). In some embodiments, an electronic controller for transmitting a control signal to an electronic flow control valve may be distinct from other electronic components in a gas flow control system, such as microprocessors and other electronic components associated with displays, touch screens, data storage, data connectivity, etc. The reliability of the electronic flow controls may be improved by separating the electronic flow controls from other electronic features of an anesthesia delivery device and/or by implementing them in hardware rather than software.

While the various examples and embodiments disclosed herein are described in conjunction with a gas flow control system, many of the embodiments could be used or modified for use with any type of fluid, including various gases and liquids. Gases used for anesthesia delivery, such as oxygen, nitrous oxide, and air, are used herein as examples of gases that can be controlled via the presently described fluid flow control systems and are referred to as gas flow control systems.

Some of the infrastructure that can be used with embodiments disclosed herein is already available, such as general-purpose computers, computer programming tools and techniques, digital storage media, and communication networks. A computing device or other electronic controller may include a processor, such as a microprocessor, a microcontroller, logic circuitry, and/or the like. The processor may include a special purpose processing device such as application-specific integrated circuits (ASIC), programmable array logic (PAL), programmable logic array (PLA), a programmable logic device (PLD), FPGA, or another customizable and/or programmable device. The computing device may also include a machine-readable storage device, such as non-volatile memory, static RAM, dynamic RAM, ROM, CD-ROM, disk, tape, magnetic, optical, flash memory, or another machine-readable storage medium. Various aspects of certain embodiments may be implemented using hardware, software, firmware, or a combination thereof.

The embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps need to be executed only once.

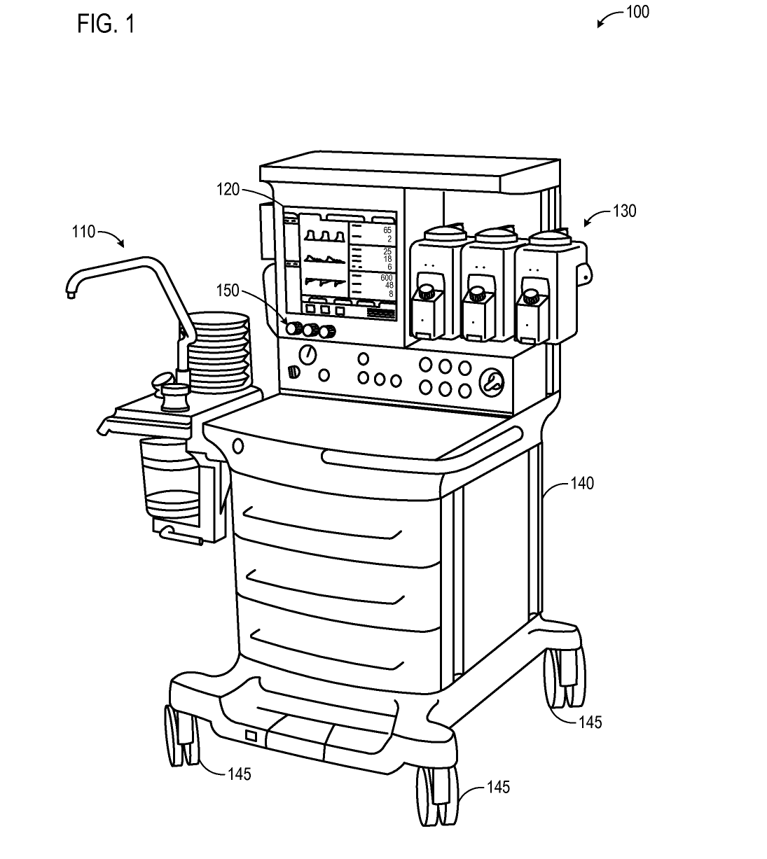

FIG. 1 illustrates an anesthesia delivery machine 100 configured with three manual flow selectors 150, one each for controlling the flow of oxygen, nitrous oxide, and air. The illustrated anesthesia delivery machine 100 may include a breathing system 110, anesthetic gas vaporizers 130, and/or other components of an anesthetic delivery system. The anesthesia delivery machine 100 may include a cart 140 and/or wheels 145 for portability. An electronic display 120 may provide information regarding the flow rate and/or anesthetic delivery process to a practitioner. Additionally, the electronic display 120 may be configured as a touch sensitive display to allow a practitioner to provide inputs or selections associated with the displayed content.

In various embodiments, a user may rotate a manual flow selector 150 (e.g., a rotatable knob) clockwise or counterclockwise in order to decrease or increase, respectively, the flow rate of a particular fluid (e.g., oxygen, nitrous oxide, air). In various embodiments, the number of manual flow selectors 150 may correspond to the number of available fluids for control. Accordingly, any number of manual flow selectors may be utilized based on the number of available gases (or other fluids).

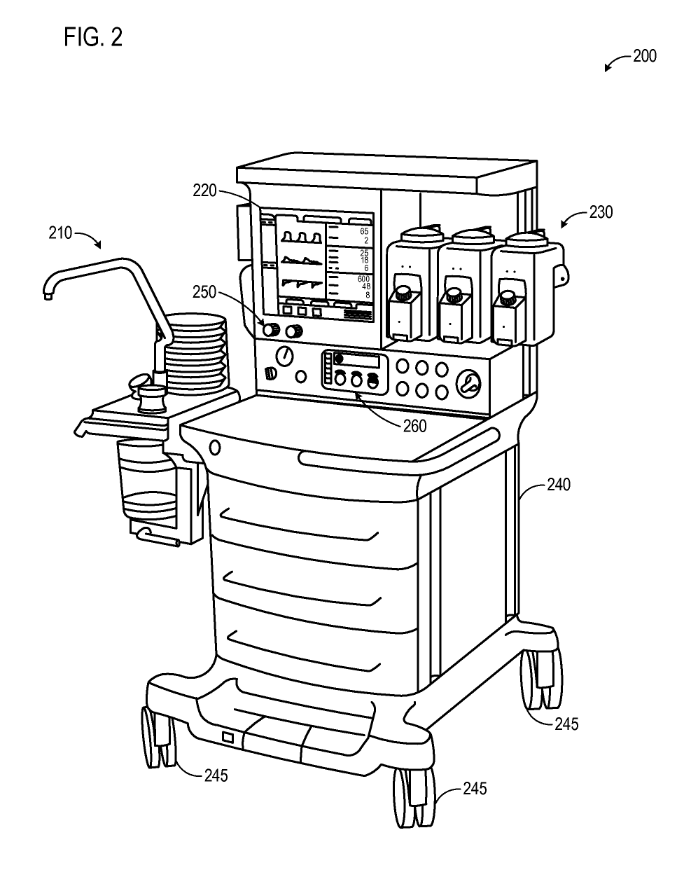

FIG. 2 illustrates an anesthesia delivery machine 200 configured with two electronic flow selectors 250, configurable to selectively control each of three gases, oxygen, nitrous oxide, and air. The anesthesia delivery machine 200 also includes three backup manual flow selectors 260, for controlling each of the three gases. The anesthesia delivery machine 200 may include a breathing system 210, anesthetic gas vaporizers 230, and/or other components of an anesthetic delivery system. The anesthesia delivery machine 200 may include a cart 240 and/or wheels 245 for portability. An electronic display 220 may provide information regarding the flow rate and/or anesthetic delivery process to a practitioner. Additionally, the electronic display 220 may be configured as a touch sensitive display to allow a practitioner to provide a selection of a flow rate. The electronic display 220 may be configured to allow a practitioner to select a flow rate of one or more gases using a peripheral input device, such as a microphone, a mouse, a keyboard, or a joystick.

The three backup manual flow selectors 260 may remain retracted and/or disabled when the anesthesia delivery machine 200 is in an electronic mode. When the anesthesia delivery machine 200 enters a manual mode (e.g., due to power loss or a user selection), the three backup manual flow selectors 260 may be deployed, unlocked, and/or otherwise functional. As previously described, various internals, switches, normally-open valves, normally-closed valves, three-way valves, and/or other components may regulate the flow of gases within the anesthesia delivery machine 200 based on whether it is in a manual mode or an electronic mode.

In an electronic mode, backup manual flow selectors 260 may be retracted, locked, disengaged, and/or otherwise non-operational. The flow rate of two or more gases may be controlled by the electronic flow selectors 250 and/or via electronic inputs associated with display 220. The anesthesia delivery system may enter a manual mode due to the loss of power, in response to an electronic or a mechanical failure, and/or in response to a user selecting a manual mode.

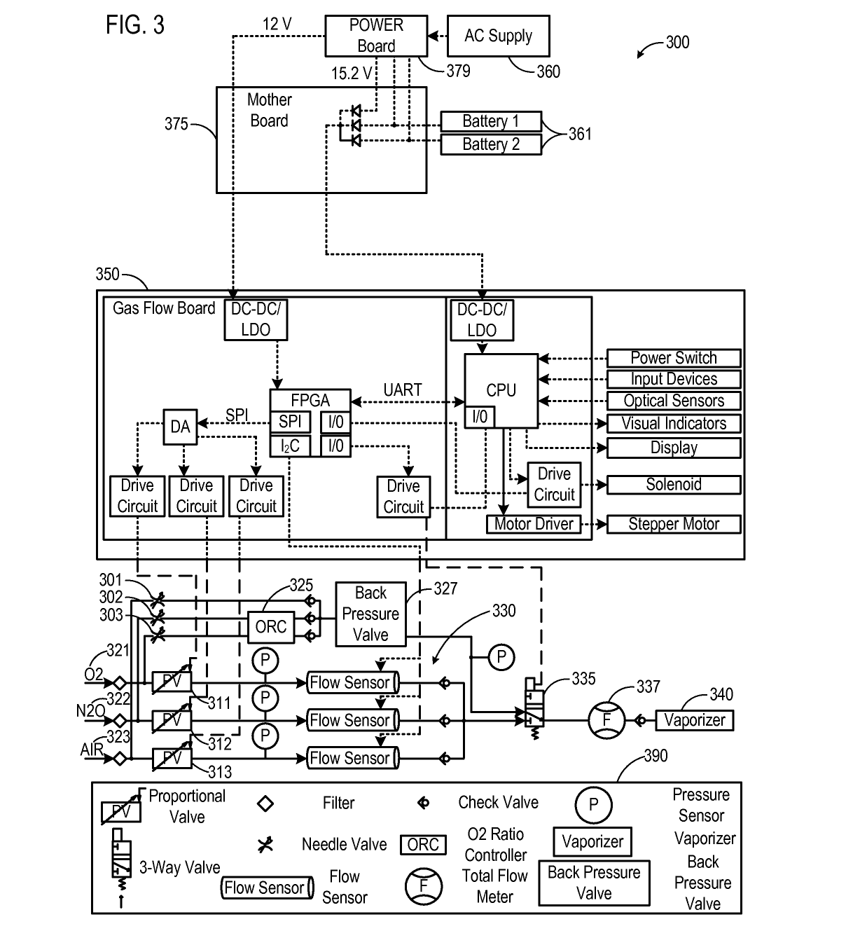

FIG. 3 illustrates a diagram 300 of an anesthesia delivery system configured with electronic flow control valves 311, 312, and 313 and backup mechanical flow control valves 301, 302, and 303 for controlling the flow of oxygen 321, nitrous oxide 322, and air 323. When power is available via AC supply 360 and/or batteries 361, the anesthesia delivery system may utilize electronic flow control valves 301, 302, and 303 controlled by one or more electronic flow selectors. The power input may be converted and/or inverted as necessary by a power board 379 and/or motherboard 375. A gas flow board 350 may include various monitoring and/or control components for electronically monitoring, regulating, and/or controlling the flow of gases within the anesthesia delivery system.

In various embodiments, the anesthesia delivery system may include various components and/or interface with various components via the gas flow board 350. For example, the gas flow board 350 may include and/or communicate with various FPGAs, CPUs, microprocessors, logic circuits, drive circuits, digital to analog converters, analog to digital converters, drive circuits, motor drivers, power switches, input devices, optical sensors, visual indicators, displays, solenoids, stepper motors, touch panels, and/or peripheral devices. Additionally, the gas flow board 350 may include and/or communicate with motor position switches, an LED, needle valve switches, a gas source, and/or other selection inputs. A practitioner may interact with the anesthesia delivery machine by providing inputs with regard to a flow of one or more gases. For instance, a practitioner may provide an input via an electronic flow selector. The electronic flow selector may comprise a mechanically rotatable knob and a rotary encoder. Similarly, a practitioner may provide an input via a touch screen display or peripheral input devices associated with a display. The on-screen controls and/or electronic flow selectors may allow a practitioner to select a flow rate of one or more gases in a total flow control mode or a direct flow control mode, as described herein.

When the anesthesia delivery system is in a powered state, the user may select an electronic mode or a manual mode. When the anesthesia delivery system is in an unpowered state, the anesthesia delivery system may be used in a manual mode. In the electronic mode, the three source gases, oxygen 321, nitrous oxide, 322, and air 323, may flow through the electronic flow control valves 311, 312, and 313, an oxygen ratio controller 325, and/or check valves 330 and flow sensors. In a manual mode, the three source gases 321, 322, and 323 may flow through backup mechanical flow control valves 301, 302, and 303, oxygen ratio controller 325, and/or backpressure valve 327.

As described herein, a user may select a flow rate of a combination of oxygen and air to be supplied to a patient. A user may also select a flow rate of nitrous oxide to be provided to a patient instead of air. In some embodiments, the nitrous oxide may be supplied in addition to air. Regardless of the selections made by a user, a safe amount of oxygen may be automatically supplied to the patient, as ensured by the oxygen ratio controller (ORC) 325.

In various embodiments, a user may achieve a desired ratio of gases 321, 322, and 323 by starting with zero flow and sequentially adding source gases to the total flow, noting the effect of each on total flow rate. In an alternative embodiment, the user may achieve a desired ratio of gases 321, 322, and 323 by starting at a “home state” flow of oxygen 321 and then adjusting each of the gases 321, 322, and 323 to achieve the desired flow rate. The oxygen ratio controller 325 may ensure a clinically safe ratio of oxygen to nitrous oxide. The check valves 330 may prevent back flow of gases 321, 322, and 323 due to potential higher downstream pressures.

In either flow control mode, after passing through the check valves 330, the flows of the three gases 321, 322, and 323 may be combined into a single flow, which may be measured by a total flow meter, and pass through a total flow meter 337. An anesthetic gas vaporizer 340 may vaporize an anesthetic into the gases. A three-way selector valve 335 may be used to direct a flow of gases from only one of the backup mechanical flow control valves 301, 302, and 303 and the electronic flow control valves 311, 312, and 313. Alternatively, the three-way selector valve may comprise a one or more normally-open and/or normally-closed valves. Alternative diversion valve systems may be employed in place of a three-way selector valve 335 and/or normally-open and/or normally-closed valves.

In an electronic mode, flow control selectors associated with the backup mechanical flow control valves 301, 302, and 303 may be disabled, retracted, locked, and/or otherwise disengaged. In a manual mode (whether entered due to power loss or user selection), flow control selectors associated with the needle valves 301, 302, and 303 may be enabled, deployed, unlocked, and/or otherwise engaged. Various elements of the diagram 300 are illustrated in the key 390 and are not described in detail herein. Additionally, any of a wide variety of components, measurement devices, monitoring devices, and/or control devices configured for use in anesthesia delivery systems, gas delivery systems, liquid delivery systems, and/or other related systems may be added to, supplemented within, and/or replace components within the illustrated system.

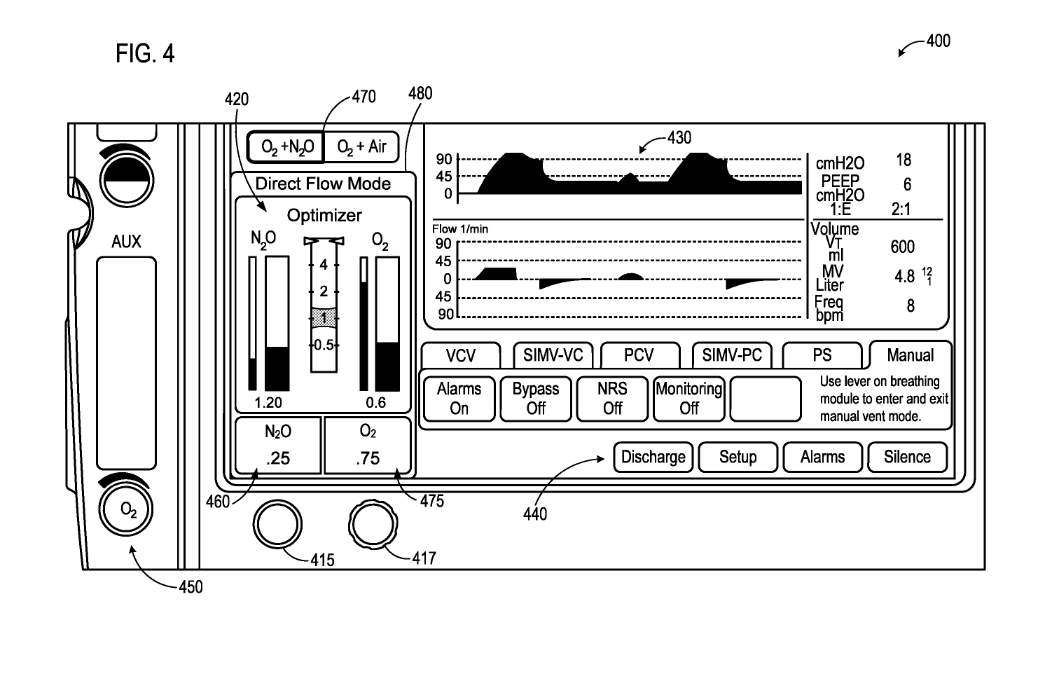

FIG. 4 illustrates a close-up view of a control panel 400 of an anesthesia delivery machine, including two electronic flow selectors 415 and 417 selectively configurable to directly control either oxygen and nitrous oxide or oxygen and air, at 470, in a direct flow control mode, at 480. As illustrated, the anesthesia delivery machine may include a panel 430 to display various telemetry data associated with a patient, information associated with the flow rate of gases, and/or information associated with the delivery of one or more anesthetics. Various inputs 440 may be available to change the display of panel 430 and/or to control the anesthesia delivery machine. In some embodiments, panel 430 may provide on-screen controls for a practitioner to select the flow rate of gases.

In a first position, a selection toggle 470 may allow a practitioner to control the flow rate of oxygen and nitrous oxide via the respective electronic flow selectors 415 and 417 (or via an on-screen display within panel 430). In a second position, the selection toggle 470 may allow a practitioner to control the flow rate of oxygen and air via the respective flow selectors 415 and 417. Depending on the position of the selection toggle 470, various flow rate monitoring devices and ratio measuring devices 420 may indicate the flow rate of one or more gases and/or a combination of gases. In various embodiments, auxiliary inputs and outputs 450 for oxygen and/or another gas may be available.

While the illustrated embodiment shows two electronic flow selectors 415 and 417, any number of flow selectors and associated gases may be utilized. For example, a flow control system may be configured to allow for the electronic and backup manual control of one, two, three, four . . . or N number of gases or liquids. In some embodiments, more than one flow selector (e.g., knob, toggle, dial, slider, switch) may be configured to control the flow rate of the same gas. An additional selection toggle 470 and/or a multi-position selection toggle may be used to control the number of gases controlled by any number of corresponding flow control selection knobs. The flow selectors may include and/or utilize any analog or digital selection mechanism for selecting a flow rate, including knobs as illustrated in the figures.

In the direct flow control mode, at 480, a first flow selector 415 may be utilized to directly select the flow rate of either nitrous oxide or air, depending on which balance gas is selected via selection toggle 470. A second flow selector 417 may be utilized to directly select the flow rate of oxygen. As previously described, a rotary encoder associated with each of electronic flow selectors 415 and 417 may encode the selection. An electronic controller may then use the encoded selections to control the flow rate of the respective gases through an electronic flow control valve, such as an electronic proportional valve.

Numeric values 460 and 475 and associated graphical representations 420 may be displayed as a direct flow rate (e.g., liters per minute) or as a percentage flow rate for each controlled gas. Alternatively, the numeric values 460 and 475 and/or the graphical representations 420 may display the selected flow rates of each gas, a total flow rate, the ratio of the two gases, the total flow rate with respect to an optimum flow rate, and/or other numeric values, charts, graphs, percentages, and the like associated with the flow rates. In the illustrated embodiments, nitrous oxide is illustrated as representing one fourth (¼ or 0.25) of the total flow rate of the gases and oxygen is illustrated as representing three-fourths (¾ or 0.75) of the total flow rate of the gases.

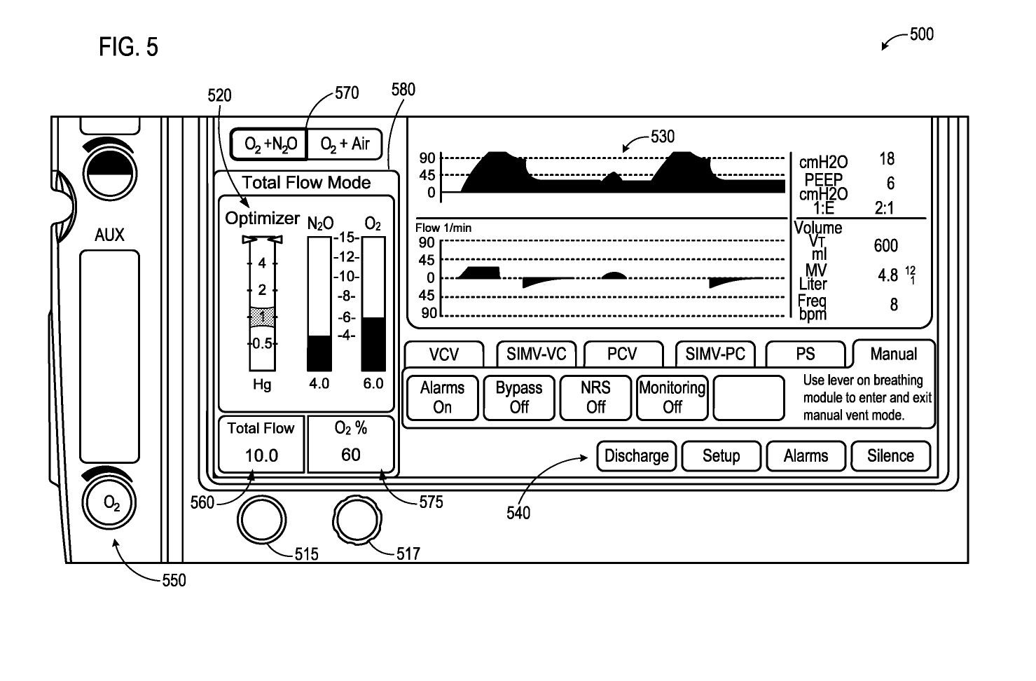

FIG. 5 illustrates a close-up view of a control panel 500 of an anesthesia delivery machine, including two electronic flow selectors 515 and 517 selectively configurable to directly control either oxygen and nitrous oxide or oxygen and air, at 570, in a total flow control mode, at 580. As illustrated, the anesthesia delivery machine may include a panel 530 to display various telemetry data associated with a patient, information associated with the flow rate of gases, and/or information associated with the delivery of one or more anesthetics. The panel 530 may also provide an on-screen display configured to allow a user to select flow rates of gases in addition to or in place of electronic flow selectors 515 and 517. Other inputs 540 may be available to change the display of panel 530 and/or to control the anesthesia delivery machine.

In a first position, a selection toggle 570 may allow a practitioner to control the flow rate of oxygen and nitrous oxide via the respective electronic flow selectors 515 and 517. In a second position, the selection toggle 570 may allow a practitioner to control the flow rate of oxygen and air via the respective flow selectors 515 and 517. Depending on the position of the selection toggle 570, various flow rate monitoring devices and ratio measuring devices 520 may indicate the flow rate of one or more gases and/or a combination of gases. In various embodiments, auxiliary inputs and outputs 550 for oxygen and/or another gas may be available.

While the illustrated embodiment shows two electronic flow selectors 515 and 517, any number of flow selectors and associated gases may be utilized. For example, a flow control system may be configured to allow for the electronic and backup manual control of one, two, three, four . . . or N number of gases or liquids. In some embodiments, more than one flow selector (e.g., knob, toggle, dial, slider, switch) may be configured to control the flow rate of the same gas. An additional selection toggle 570 and/or a multi-position selection toggle may be used to control the number of gases controlled by any number of corresponding flow control selection knobs. The flow selectors may include and/or utilize any analog or digital selection mechanism for selecting a flow rate, including knobs as illustrated in the figures.

In the total flow control mode, at 580, the first electronic flow selector 515 is used to adjust the total flow rate of the gases. That is, the first electronic flow selector 515 may be used to adjust the total flow rate of the selected balance gas (air or nitrous oxide) combined with the oxygen. The second electronic flow selector 517 may be used to control the concentration of oxygen to mix with the selected balance gas (air or nitrous oxide), depending on which balance gas is selected via selection toggle 570. The selections may be encoded by a rotary encoder and transmitted to an electronic controller. The ratio and necessary flow rates may be computed by the electronic controller. The electronic controller may then use the encoded selections to control the flow rate of the respective gases through an electronic flow control valve, such as an electronic proportional valve.

Numeric values 560 and 575 and associated graphical representations 520 may be displayed as a direct flow rate (e.g., liters per minute) or as a percentage flow rate for each controlled gas. Alternatively, the numeric values 560 and 575 and/or the graphical representations 520 may display the selected flow rates of each gas, a total flow rate, the ratio of the two gases, the total flow rate with respect to an optimum flow rate, and/or other numeric values, charts, graphs, percentages, and the like.

In the illustrated embodiments, nitrous oxide is illustrated as the selected balance gas, at 570. The first electronic flow selector 515 has been used to select a total flow rate of 10.0. The total flow rate may be unit-less, measured in liters per minute, kilograms per minute, and/or another volume or weight unit with respect to time. The second electronic flow selector 517 may be used to select the percentage of the oxygen (illustrated as 60 percent) in the total flow of gases.

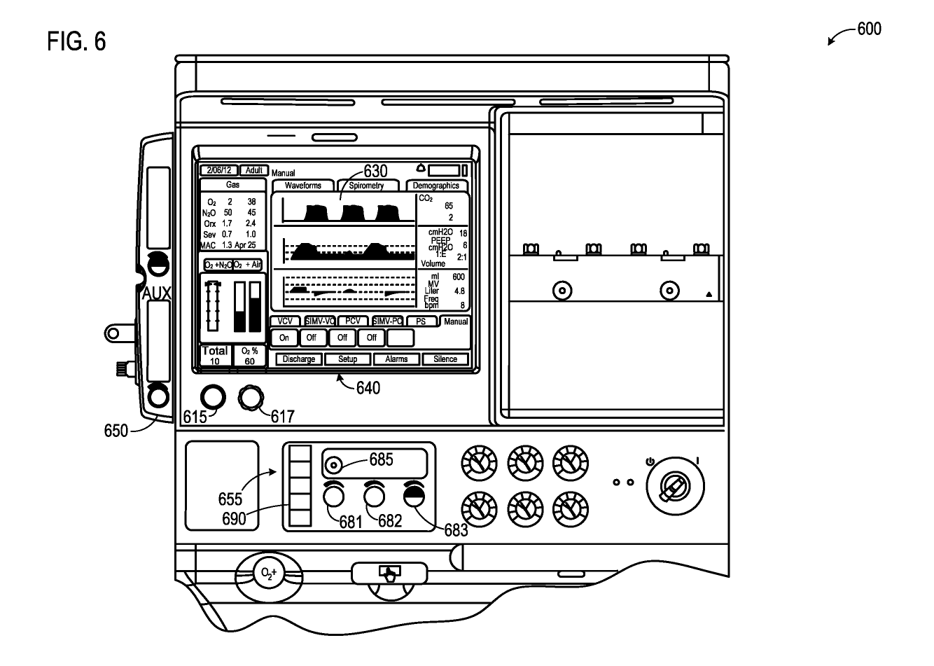

FIG. 6 illustrates a wider view of a control panel 600 of an anesthesia delivery machine, including dual mode electronic flow selectors 615 and 617 and backup mechanical flow controls 681, 682, and 683 for controlling the flow of three gases independently. When the anesthesia delivery system is in an electronic mode, the two electronic flow control selectors 615 and 617 may be used to control either oxygen and nitrous oxide or oxygen and air, depending on the selection made via a selection toggle.

Additionally, in an electronic mode, an on-screen display selectable within panel 630 may be available to allow a user to select the flow rate of oxygen and nitrous oxide or air, depending on the selection made via the selection toggle or a similar toggle within the on-screen display. The electronic display 630 may also display information associated with the flow rate of one or more gases, an anesthetic, and/or patient telemetry data. Various touch inputs 640 may be available. An auxiliary control panel 650 may allow for one or more gases to be supplied to an auxiliary device.

A mode selector may be used to select either a direct flow control mode or a total flow control mode. In a direct flow control mode, a first electronic flow selector may be used to directly adjust the flow rate of either nitrous oxide or air, depending on the selected balance gas. A second electronic flow selector may be used to directly adjust the flow rate of oxygen. A digital display 630 associated with the selected flow rates may display the selected flow rates of each gas, a total flow rate, the ratio of the two gases, the total flow rate with respect to an optimum flow rate, and/or other numeric values, charts, graphs, percentages, and the like. The digital display 630 may also allow for digital selections of flow rates associated with each gas, the total flow rate, the ratio of the flow rates of the gases, etc.

The same system may be selectively used in a total flow control mode. In a total flow control mode, a first electronic flow selector may be used to adjust the total flow rate of the gases, including the selected balance gas (air or nitrous oxide) and the oxygen. A second electronic flow selector may be used to control the concentration of oxygen to mix with the selected balance gas (air or nitrous oxide). The selections may be encoded by one or more rotary encoders and transmitted to an electronic controller. The ratio and necessary flow rates may be computed by the electronic controller. The electronic controller may then use the encoded selections to control the flow rate of the respective gases through an electronic flow control valve, such as an electronic proportional valve.

Numeric values and associated graphical representations may be displayed as a direct flow rate (e.g., liters per minute) or as a percentage flow rate for each controlled gas. Alternatively, the numeric values and/or the graphical representations may display the selected flow rates of each gas, a total flow rate, the ratio of the two gases, the total flow rate with respect to an optimum flow rate, and/or other numeric values, charts, graphs, percentages, and the like. An on-screen display within display 630 may allow for numeric and/or other digital control of the flow rates, as described in greater detail below.

When the anesthesia delivery system is in an unpowered state and/or the user has selected a manual mode, the anesthesia delivery system may be in a manual mode. In a manual mode, the flow rate of one or more gases and/or the amount of anesthetic delivery may be controlled via a manual panel 655. The electronic display 630, the touch inputs 640, the electronic flow control selectors 615 and 617, and other electronic components may be unavailable in an unpowered state and one or more of them may be unavailable and/or otherwise disabled in a manual mode selected when in a powered state.

The manual panel 655 may include a total flow rate indicator 690, a manual mode selector 685 (e.g., a spring-loaded plunger), and one or more manually operated flow control selectors 681, 682, and 683. According to various embodiments, a manually operated flow control selector may be available for each available gas or for each available critical gas. In various embodiments, manually operated flow control selectors 681, 682, and 683 may be disabled, retracted, locked, and/or otherwise not operational when the anesthesia delivery system is in an electronic mode. In a manual mode, the manually operated flow control selectors 681, 682, and 683 may be enabled, deployed, unlocked, and/or otherwise become operational.

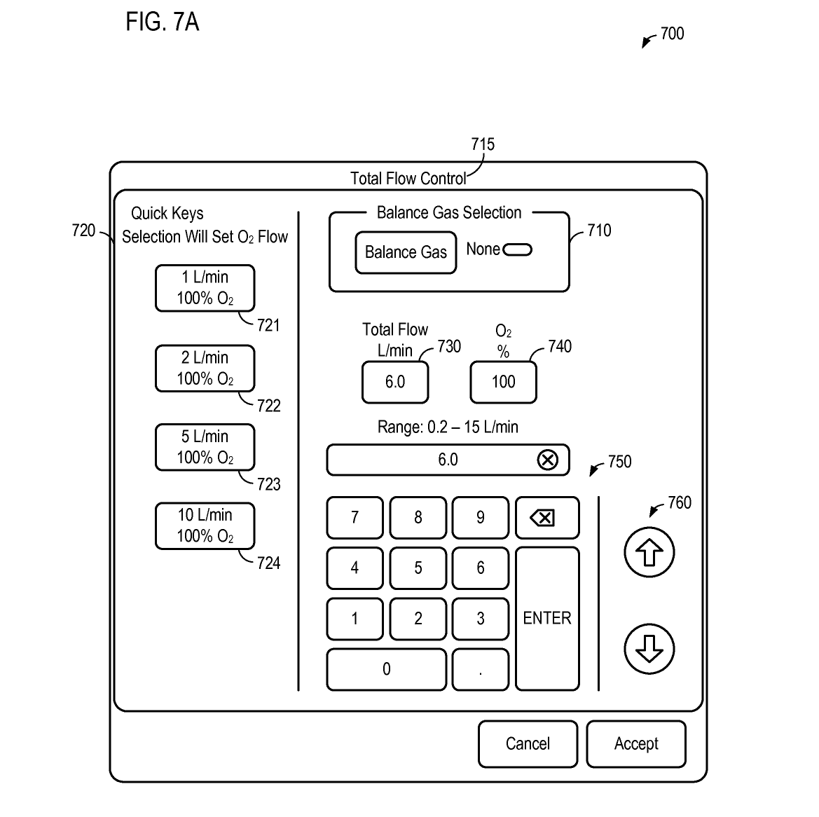

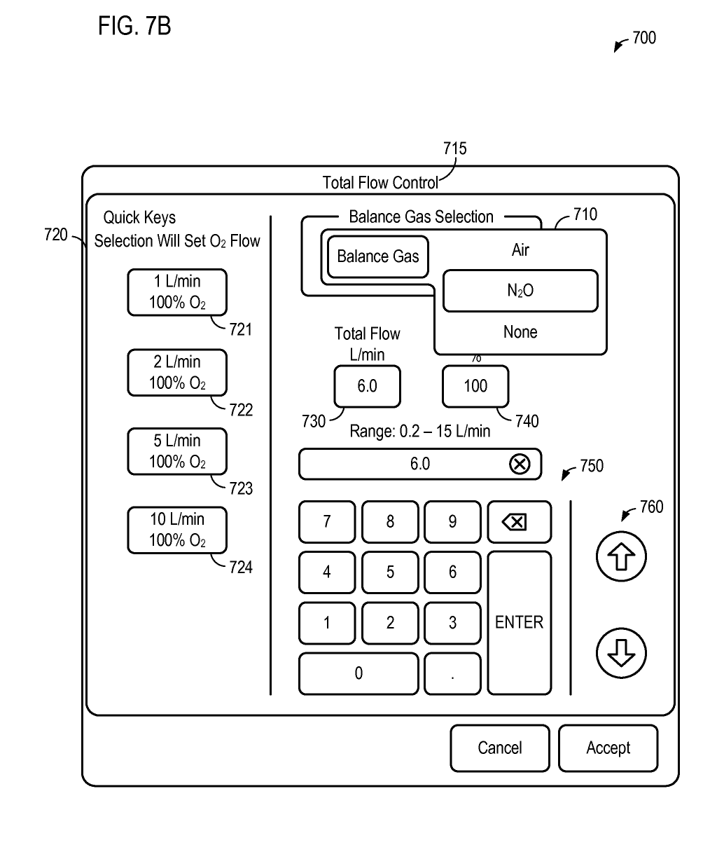

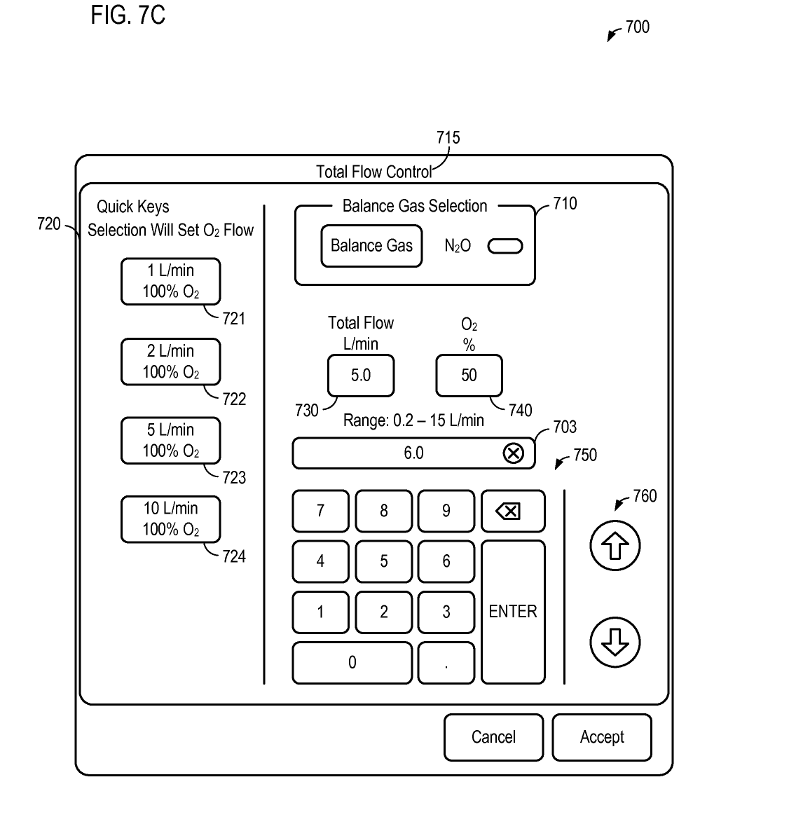

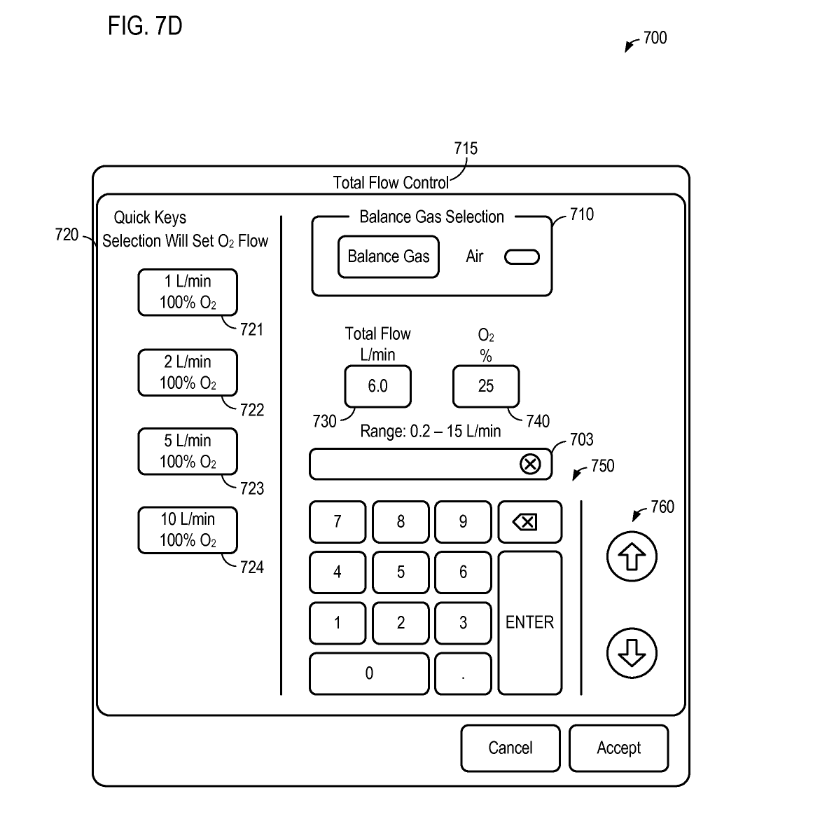

FIG. 7A illustrates an on-screen display 700 configured to allow a user to select the relative flow rates of oxygen 740 and a balance gas 710 (air or nitrous oxide) in a total flow control mode 715. As illustrated, the on-screen display 700 may include various icons, panels, buttons, toggles, entry fields, and/or other inputs and displays. In the illustrated embodiment, the on-screen display 700 may be a graphical user interface configured to be interacted with via one or more peripheral interface devices and/or via a touch screen interface. The on-screen display 700 may be displayed on an electronic display based on instructions executed on a processor. The instructions may be stored on any of a wide variety of non-transitory mediums.

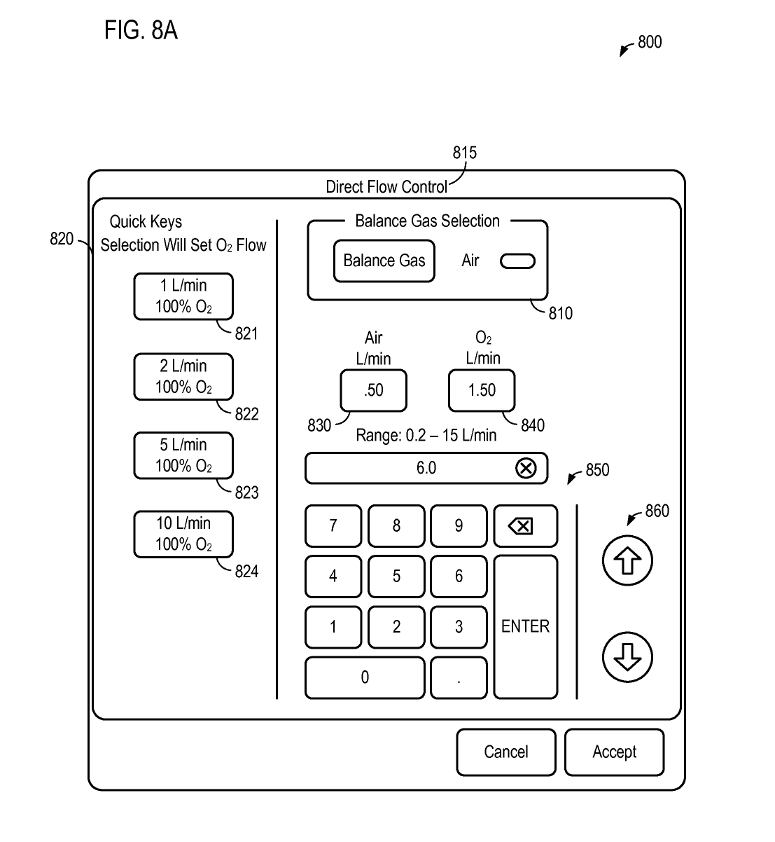

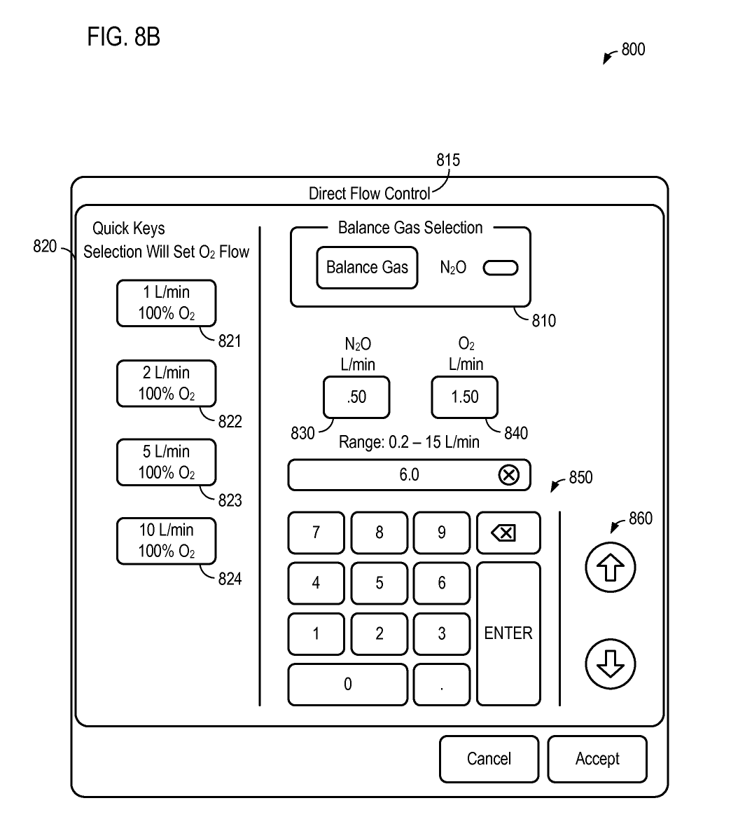

The on-screen display 700 may be configured to allow a practitioner to control the flow rate of one or more fluids. A user may select either a direct flow control mode or a total flow control mode, at 715. FIGS. 7A-7D illustrates a total flow control mode, at 715, while FIGS. 8A-8B illustrate a direct flow control mode.

As illustrated in FIG. 7A, in a total flow control mode, at 715, a user may select a total flow rate for all gases, at 730. An input field may be used to enter a numeric value using keypad 750, or up/down arrows 760 may be used to increase or decrease the total flow rate of the combined gases, at 730. A selection of a flow rate for oxygen, at 740, may be provided as well. Accordingly to various embodiments, a numeric value for the flow rate of oxygen, at 740, may be provided as a percentage or ratio of the total flow rate, at 730. Additionally or alternatively, a numeric value corresponding to a specific flow rate for oxygen may be provided. In various embodiments, a quick key panel 720 may include a plurality of quick keys 721, 722, 723, and 724. Each quick key 721, 722, 723, and 724 may allow a user to quickly select a specific flow rate of oxygen as illustrated. In an alternative embodiment, one or more quick keys may be configured to allow for the selection of a total flow rate as well.

The total flow rate, at 730, may correspond to the flow rate of the oxygen (specified as a ratio, percentage, weight, volume, etc) combined with a flow rate of a balance gas. A balance gas selection panel 710 may allow a user to select a balance gas. In the illustrated embodiment, no balance gas has been selected. In some embodiments, 100 percent oxygen may be supplied. In other embodiments, a maximum allowable oxygen ratio may be maintained and the balance of the gas may be automatically selected as either nitrous oxide or air.

FIG. 7B illustrates the on-screen display 700 for selecting the relative flow rates of oxygen 740 and a balance gas 730 in the total flow control mode, at 715, including a drop down menu 710 for selecting a balance gas. As illustrated, the balance gas in various embodiments may either be air or nitrous oxide. The balance gas, at 710, the total flow rate, at 730, the oxygen flow rate, at 740, and/or other inputs may be provided via a touch interface, a mouse, a joystick, voice inputs, gestures, and/or via any of a wide variety of other peripheral input devices.

FIG. 7C illustrates the on-screen display 700 with oxygen set at 50 percent, at 740, and total flow (oxygen and the balance gas) set at 5.0 liters per minute, at 730. Nitrous oxide has been selected as a balance gas within balance gas selection panel 710. An intermediary value of 6.0 has been entered in intermediate field 703. According to various embodiments, the intermediate value of 6.0 may then be assigned by the user to the total flow field, 730, in order to select a new total flow rate of 6.0 liters per minute. An electronic controller, including a processing device, may determine the necessary flow rates for each gas and transmit a signal to the appropriate electronic control valve to achieve the selected flow rates. For example, by increasing the total flow rate from 5.0 to 6.0 liters per minute with oxygen set at 50 percent, the processer may transmit a signal to each electronic control valve in order to increase the flow rates of both oxygen and nitrous oxide from 2.5 liters per minute to 3.0 liters per minute.

As another example, if the ratio of oxygen were increased, at 740, from 50 percent to 60 percent while maintaining a total flow rate of 5.0 liters per minute, the flow rate of oxygen may be increased to 3.0 liters per minute while the flow rate of nitrous oxide may be decreased to 2.0 liters per minute. Accordingly, it can be seen that in a total flow rate mode, a single input associated with a change in the flow rate of oxygen may cause the system to automatically calculate the necessary flow rates of two or more gases and communicate with the appropriate electronic flow control valves in order to achieve the desired flow rates and ratios of gases.

FIG. 7D illustrates the on-screen display 700 with air selected as a balance gas via the balance gas selection panel, at 710. The intermediary field, at 703, is empty and the total flow rate has been set at 6.0 liters per minute, at 730. The oxygen ratio has been set at 25 percent, at 740. Accordingly, signals may be sent to each of the associated electronic flow control valves to decrease the flow rate of oxygen to 1.5 liters per minute, decrease the flow rate of nitrous oxide to 0.0 liters per minute, and increase the flow rate of air to 4.5 liters per minute.

FIG. 8A illustrates the on-screen display 800 for selecting the relative flow rate of oxygen, at 840, and air, at 830, in a direct flow control mode, at 815. As illustrated, the on-screen display 800 may include various icons, panels, buttons, toggles, entry fields, and/or other inputs and displays. In the illustrated embodiment, the on-screen display 800 may be a graphical user interface configured to be interacted with via one or more peripheral interface devices and/or via a touch screen interface. The on-screen display 800 may be displayed on an electronic display based on instructions executed on a processor. The instructions may be stored on any of a wide variety of non-transitory mediums.

The on-screen display 800 may be configured to allow a practitioner to control the flow rate of one or more fluids, such as oxygen, nitrous oxide, and air in gaseous phases. A user may select either a direct flow control mode or a total flow control mode, at 815. FIGS. 8A-8B illustrate the on-screen display 800 in the direct flow control mode. Accordingly to various embodiments, a user may switch between the total flow control mode and the direct flow control mode prior to use and/or anytime during use. In some embodiments, a mode selection interface may be used to select the flow control mode. The mode selection interface may be implemented in any of a wide variety of ways, including a separate screen, pop-up, icon, button, drop down menu, radio buttons, and/or the like.

As illustrated in FIG. 8A, in a direct flow control mode, at 815, a user may select a flow rate for each gas, at 830 and 840. An input field may be used to enter a numeric value using keypad 850, or up/down arrows 860 may be used to increase or decrease the flow rate of the each gas independently, at 830 and 840. In some embodiments, the flow rates may be specified as a weight or volume over a time period. In other embodiments, each fluid may be specified as a percentage of the other or as a ratio of a total flow supplemented by a third or default gas. A numeric value corresponding to a specific flow rate for each gas may be provided. In various embodiments, a quick key panel 820 may include a plurality of quick keys 821, 822, 823, and 824. Each quick key 821, 822, 823, and 824 may allow a user to quickly select a specific flow rate of oxygen as illustrated. In an alternative embodiment, one or more quick keys may be configured to allow for the selection of a flow rate for the balance gas as well. A balance gas selection panel 810 may allow a user to select a balance gas. In the illustrated embodiment, air has been selected as the balance gas.

FIG. 8B illustrates the on-screen display 800 in which nitrous oxide has been selected as the balance gas. In alternative embodiments, selection fields similar to those illustrated for nitrous oxide, at 830, and oxygen, at 840, may be present for one or more additional fluids. In some embodiments, icons, buttons, fields, or the like may be present for selecting the anesthetic, the dose of the anesthetic, and/or the timing of the release of the anesthetic on the on-screen display 800.

The illustrated embodiments in FIGS. 7A-8B are merely exemplary and are intended to illustrate the functionality of the total flow control mode and the direct flow control mode, and not the specific appearance or layout of the graphical user interface. Moreover, the on-screen displays may include any number of additional features, informational details, controls, graphs, numeric values, and/or other information associated with the supplies, flow rates, delivery rates and/or other aspects of an anesthetic delivery machine.

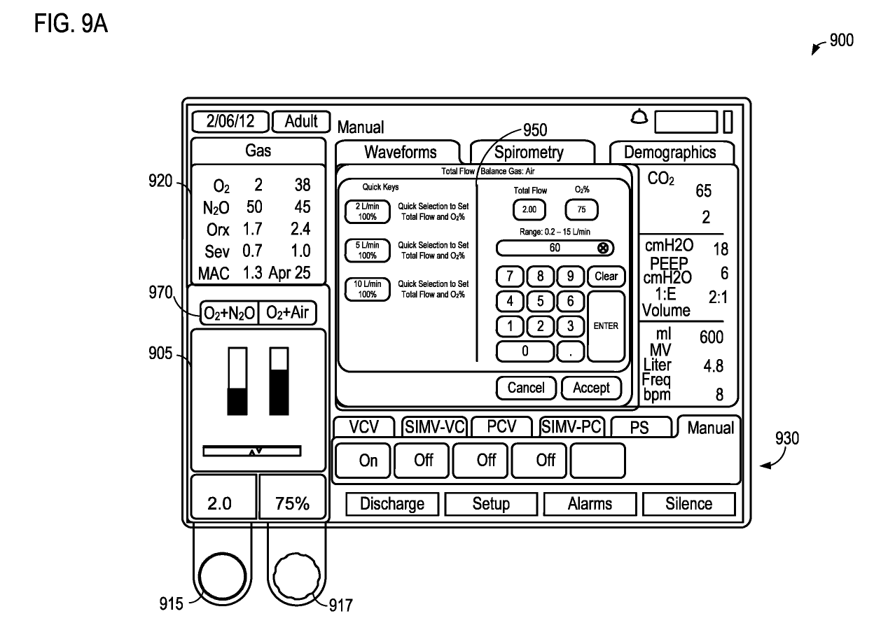

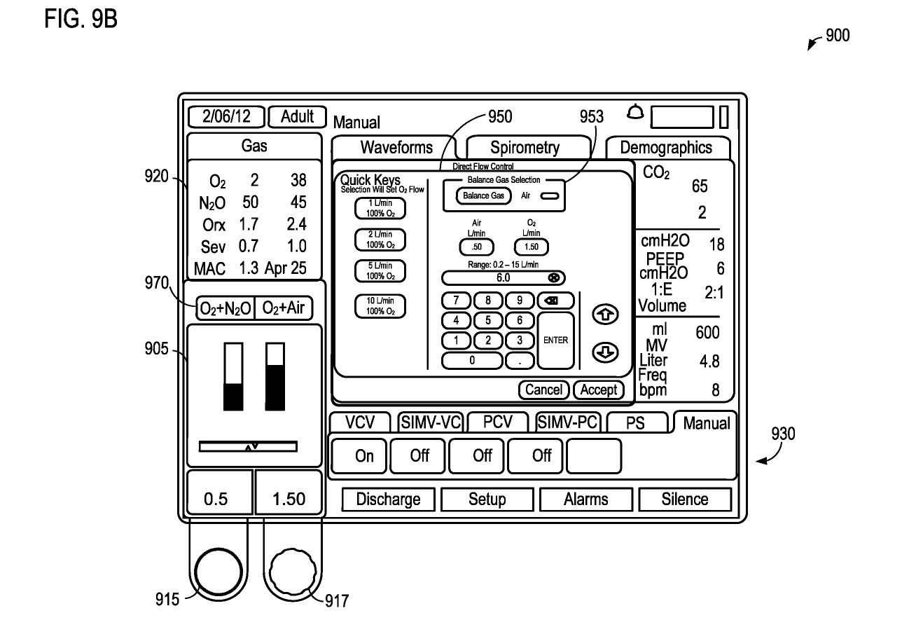

FIG. 9A illustrates a view of an on-screen display 900 of an anesthesia delivery machine for selecting the relative flow rate of oxygen and a balance gas in a total flow control mode. As illustrated, a display 950 may provide an on-screen interface for selecting the total flow of gases delivered to a patient and the flow rate, as a percentage, ratio, and/or specific value, of oxygen. The functionality of the on-screen interface may be similar to any combination of the embodiments described herein and specifically those described in conjunction with FIGS. 7A-8B.

In addition to the on-screen display on display 950, the anesthesia delivery machine may display various telemetry data associated with a patient, information associated with the flow rate of gases, and/or information associated with the delivery of one or more anesthetics on display 950. Various inputs 930 may be available to change what is displayed on display 950 and/or to control the anesthesia delivery machine.

In a first position, a selection toggle 970 may allow a practitioner to control the flow rate of oxygen and nitrous oxide via the on-screen controls in display 950 and/or via the respective electronic flow selectors 915 and 917. In a second position, the selection toggle 970 may allow a practitioner to control the flow rate of oxygen and air via the on-screen controls in display 950 and/or via the respective flow selectors 915 and 917. Depending on the position of the selection toggle 970, various flow rate monitoring devices and ratio measuring devices 905 and 920 may indicate the flow rate of one or more gases and/or a combination of gases.

While the illustrated embodiment shows two electronic flow selectors 915 and 917, any number of flow selectors and associated gases may be utilized. For example, a flow control system may be configured to allow for the electronic and backup manual control of one, two, three, four . . . or N number of gases or liquids. In some embodiments, more than one flow selector (e.g., knob, toggle, dial, slider, switch) may be configured to control the flow rate of the same gas. An additional selection toggle 970 and/or a multi-position selection toggle may be used to control the number of gases controlled by any number of corresponding flow control selection knobs. The flow selectors may include and/or utilize any analog or digital selection mechanism for selecting a flow rate, including knobs as illustrated in the figures.

In the total flow control mode the first electronic flow selector 915 is used to adjust the total flow rate of the gases. That is, the first electronic flow selector 915 may be used to adjust the total flow rate of the selected balance gas (air or nitrous oxide) combined with the oxygen. The second electronic flow selector 917 may be used to control the concentration of oxygen to mix with the selected balance gas (air or nitrous oxide), depending on which balance gas is selected via selection toggle 970. The selections may be encoded by a rotary encoder and transmitted to an electronic controller. The ratio and necessary flow rates may be computed by the electronic controller. The electronic controller may then use the encoded selections to control the flow rate of the respective gases through an electronic flow control valve, such as an electronic proportional valve.

Numeric values and associated graphical representations 905 and 920 may be displayed as a direct flow rate (e.g., liters per minute) or as a percentage flow rate for each controlled gas. Alternatively, the numeric values 905 and/or the graphical representations 905 may display the selected flow rates of each gas, a total flow rate, the ratio of the two gases, the total flow rate with respect to an optimum flow rate, and/or other numeric values, charts, graphs, percentages, and/or the like.

In the illustrated embodiments, air is illustrated as the selected balance gas, at 950. The first electronic flow selector 915 has been used to select a total flow rate of 2.0. The total flow rate may be unit-less, measured in liters per minute, kilograms per minute, and/or another volume or weight unit with respect to time. The second electronic flow selector 917 may be used to select the percentage of the oxygen (illustrated as 75 percent) in the total flow of gases.

FIG. 9B illustrates a wide view of an on-screen display 950 of an anesthesia delivery machine for selecting the relative flow rate of oxygen and a balance gas in a direct flow control mode. As illustrated, in the direct flow mode, the first electronic flow selector and/or the on-screen display 950 has been used to set the flow rate of air at 0.5 liters per minute. The second electronic flow selector and/or the on-screen display 950 has been used to set the flow rate of oxygen at 1.5 liters per minute. A balance gas selection toggle 970 and/or a balance gas selection panel 953 within on-screen display 950 may be used to select a balance gas as either nitrous oxide or air. In other embodiments, any of a wide variety of fluids, including gases and liquids, may be utilized and controlled.

A gas flow control system, according to any of the various embodiments described herein, may be used in conjunction with any of a wide variety of applications. In the illustrated embodiments, the gas flow control systems are shown as parts of anesthesia delivery systems. In such embodiments, the combined flow of one or more gases may be injected or otherwise infused with anesthesia, such as via a vaporizer, for a controlled delivery of the anesthesia and/or the one or more gases to a patient.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. The scope of the present invention should, therefore, be determined by the following claims.

What is claimed is:

1. A fluid flow control system for controlling the flow rate of a fluid, comprising:
a first electronic flow control valve configured to selectively control the flow rate of a first fluid;
a second electronic flow control valve configured to selectively control the flow rate of a second fluid;
a processor; and
a non-transitory computer-readable storage medium in communication with the processor, the computer-readable storage medium comprising instructions to cause the processor to perform a method comprising:
displaying a graphical user interface;
receiving a selection of one of a direct flow control mode and a total flow control mode;
receiving one of:
a selection of a total flow rate of the first and second fluids when the total flow control mode is selected; and
a selection of a flow rate of the first fluid when the direct flow control mode is selected;
receiving a selection of a flow rate of the second fluid; and
transmitting a control signal to each of the first and second electronic flow control valves to control the flow rate of the first and second fluids, based on the received selections of flow rates.

2. The fluid flow control system of claim 1, wherein the second fluid comprises oxygen.

3. The fluid flow control system of claim 1, wherein the first fluid comprises one or more of nitrous oxide and air.

4. The fluid flow control system of claim 1, wherein the method further comprises receiving a selection of the first fluid as one of nitrous oxide and air.

5. The fluid flow control system of claim 1, wherein the graphical user interface comprises a balance gas selection panel configured to allow for the selection of the first fluid as one or more of nitrous oxide and air.

6. The fluid flow control system of claim 1, wherein the graphical user interface comprises a plurality of quick keys configured to allow for the selection of a corresponding plurality of flow rates of the second fluid.

7. The fluid flow control system of claim 1, wherein the graphical user interface comprises a mode selection interface configured to allow for the selection of one of the direct flow control mode and the total flow control mode.

8. The fluid flow control system of claim 1, wherein the graphical user interface comprises:
a first input field for receiving:
a selection of a total flow rate of the first and second fluids when the total flow control mode is selected; and
a selection of a flow rate of the first fluid when the direct flow control mode is selected; and
a second input field for receiving a selection of a flow rate of the second fluid.

9. The fluid flow control system of claim 1, wherein receiving a selection of the flow rate comprises receiving a numeric value associated with the flow rate; and
wherein the graphical user interface comprises a numeric keypad configured to allow for numeric value inputs.

10. The fluid flow control system of claim 1, wherein when the total flow control mode is selected, receiving a selection of the flow rate of the second fluid comprises receiving a selection of a ratio of the second fluid relative to the total flow rate.

11. The fluid flow control system of claim 1, wherein each of the first and second electronic flow control valves comprises an electronic proportional valve.

12. The fluid flow control system of claim 1, further comprising a vaporizer configured to inject an anesthetic into at least one of the first and second fluids.

13. A fluid flow control system for controlling the flow rate of a fluid, comprising:
a first electronic flow control valve configured to selectively control the flow rate of a first fluid;
a second electronic flow control valve configured to selectively control the flow rate of a second fluid;
a processor; and
a non-transitory computer-readable storage medium in communication with the processor, the computer-readable storage medium comprising instructions to cause the processor to perform a method comprising:
displaying a graphical user interface;
receiving a selection of a total flow rate of the first and second fluids; and
receiving a selection of a flow rate of the second fluid; and
transmitting a control signal to each of the first and second electronic flow control valves to control the flow rate of the first and second fluids, based on the received selections of flow rates.

14. The fluid flow control system of claim 13, wherein receiving a selection of the flow rate of the second fluid comprises receiving a selection of a ratio of the second fluid relative to the total flow rate.

15. The fluid flow control system of claim 13, wherein the second fluid comprises oxygen.

16. The fluid flow control system of claim 13, wherein the first fluid comprises one or more of nitrous oxide and air.

17. The fluid flow control system of claim 13, wherein the method further comprises receiving a selection of the first fluid as one or more of nitrous oxide and air.

18. The fluid flow control system of claim 13, wherein the graphical user interface comprises a balance gas selection panel configured to allow for the selection of the first fluid as one or more of nitrous oxide and air.

19. The fluid flow control system of claim 13, wherein the graphical user interface comprises a plurality of quick keys configured to allow for the selection of a corresponding plurality of flow rates of the second fluid.

20. The fluid flow control system of claim 13, wherein the graphical user interface comprises:
a first input field for receiving:
a selection of a total flow rate of the first and second fluids when the total flow control mode is selected; and
a selection of a flow rate of the first fluid when the direct flow control mode is selected; and
a second input field for receiving a selection of a flow rate of the second fluid.

21. The fluid flow control system of claim 13, wherein receiving a selection of the flow rate comprises receiving a numeric value associated with the flow rate; and
wherein the graphical user interface comprises a numeric keypad configured to allow for numeric value inputs.

22. The fluid flow control system of claim 13, wherein each of the first and second electronic flow control valves comprises an electronic proportional valve.

23. The fluid flow control system of claim 13, further comprising a vaporizer configured to inject an anesthetic into at least one of the first and second fluids.

24. A non-transitory computer-readable storage medium comprising instructions configured to cause a machine to perform a method for controlling the flow rate of one or more fluids via a graphical user interface, the method comprising:
receiving a selection of one of a direct flow control mode and a total flow control mode;
receiving one of:
a selection of a total flow rate of the first and second fluids when the total flow control mode is selected; and
a selection of a flow rate of the first fluid when the direct flow control mode is selected;
receiving a selection of a flow rate of the second fluid;
transmitting a control signal to a first electronic flow control valve to selectively control the flow rate of the first fluid, based on the received selections of flow rates; and
transmitting a control signal to a second electronic flow control valve to selectively control the flow rate of the second fluid, based on the received selections of flow rates.

25. The computer-readable storage medium of claim 24, wherein the method further comprises receiving a selection of the first fluid as one or more of nitrous oxide and air.

26. The computer-readable storage medium of claim 24, wherein the graphical user interface comprises a plurality of quick keys configured to allow for the selection of a corresponding plurality of flow rates of the second fluid.

27. The computer-readable storage medium of claim 24, wherein the graphical user interface comprises a mode selection interface configured to allow for the selection of one of the direct flow control mode and the total flow control mode.

28. The computer-readable storage medium of claim 24, wherein receiving a selection of the flow rate comprises receiving a numeric value associated with the flow rate; and
wherein the graphical user interface comprises a numeric keypad configured to allow for numeric value inputs.

29. The computer-readable storage medium of claim 24, wherein when the total flow control mode is selected, receiving a selection of the flow rate of the second fluid comprises receiving a selection of a ratio of the second fluid relative to the total flow rate.

30. A non-transitory computer-readable storage medium comprising instructions configured to cause a machine to perform a method for controlling the flow rate of one or more fluids via a graphical user interface, the method comprising:
receiving a selection of a total flow rate of the first and second fluids;
receiving a selection of a flow rate of the second fluid;
transmitting a control signal to a first electronic flow control valve to selectively control the flow rate of the first fluid, based on the received selections of flow rates; and
transmitting a control signal to a second electronic flow control valve to selectively control the flow rate of the second fluid, based on the received selections of flow rates.

31. The computer-readable storage medium of claim 30, wherein the method further comprises receiving a selection of the first fluid as one or more of nitrous oxide and air.

32. The computer-readable storage medium of claim 30, wherein the graphical user interface comprises a plurality of quick keys configured to allow for the selection of a corresponding plurality of flow rates of the second fluid.

33. The computer-readable storage medium of claim 30, wherein receiving a selection of the flow rate comprises receiving a numeric value associated with the flow rate; and
wherein the graphical user interface comprises a numeric keypad configured to allow for numeric value inputs.

34. The computer-readable storage medium of claim 30, wherein when the total flow control mode is selected, receiving a selection of the flow rate of the second fluid comprises receiving a selection of a ratio of the second fluid relative to the total flow rate.
